(19) United States
(12) Patent Application Publication
(10) Pub. No.: US 2005/0278449 A1
(43) Pub. Date: Dec. 15, 2005

(54) Method of restricting access to certain materials available on electronic devices

(76) Inventors: Douglas G. Moss, Troy, PA (US); Michael Stephani, Millport, NY (US)

Correspondence Address: MARK LEVY & ASSOCIATES, PLLC, PRESS BUILDING, SUITE 902, 19 CHENANGO STREET, BINGHAMTON, NY, 13901, US

(21) Appl. No.: 10/857,252

(22) Filed: May 28, 2004

(51) Int. Cl. G06F 15/16

(52) U.S. Cl. 709/228

(57) ABSTRACT

There is provided a combination of software components forming a dynamic, “smart” system for limiting access to inappropriate content available in a public computer or communications network such as the WWW. An access control mechanism having a variable sensitivity is originally set to a nominal sensitivity but may relax if the user does not attempt to access inappropriate material. If, however, a user attempts to access inappropriate material, the sensitivity of the filter is adjusted to a more restrictive sensitivity. Attempts to access inappropriate material are recorded and a temporal map is formed. Statistical analysis is performed, based on the temporal map, to predict future patterns of access attempts by a user. The sensitivity of the access control mechanism is raised and relaxed based upon a user's pattern of attempts to access inappropriate material.

### RELATED APPLICATION

This is a continuation-in-part application of, and claims priority to, U.S. Provisional Application Ser. No. 60/437,997, filed May 29, 2003 for LEVERAGING EVENT FREQUENCY AS AN ANTICIPATORY INDICATOR OF RESOURCE CONTENT IN NETWORK COMMUNICATIONS FILTERING SOFTWARE by Douglas G. Moss.

### FIELD OF THE INVENTION

The invention pertains to the field of electronic device content filtering, and more particularly to filtering HyperText Transfer Protocol (HTTP), Simple Mail Transport Protocol (SMTP), and similar transactions in a distributed communications network to identify and locate inappropriate content and dynamically control user access thereto.

### BACKGROUND OF THE INVENTION

The Internet is a vast collection (i.e., a distributed network) of international resources with no central control. Rather, it is an interconnection of a vast number of computers, each having its own individual properties and content, often linked to a network which, in turn, is linked to other networks. Many of these computers have documents written in a markup language, such as Hypertext Mark-up Language (HTML), that are publicly viewable. These HTML documents that are available for public use on the Internet are commonly referred to as web pages. All of the computers that host web pages comprise what is known today as the World Wide Web (WWW).

The WWW currently comprises an extremely large number of web pages, and that number of pages appears to be growing exponentially. A naming convention such as a Uniform Resource Locator (URL) is used to designate information on the Internet. Web pages are typically assigned to the subclass known as the Hypertext Transport Protocol (HTTP) while other subclasses exist for file servers, information servers, and other machines connected to the Internet. URLs are an important part of the Internet in that they are generally responsible for locating an individual web page and consequently are necessary for locating desired information. A user may locate a web page by entering its URL into an appropriate field of a web browser. A user may also locate web pages through a linking process from other web pages.

When a user accesses any given web page, links to other web pages may be present on the initial web page. This expanding directory structure is seemingly infinite. It can result in a single user seeking one web page and compiling, from the links on that one web page, a list of hundreds of new web pages that were previously unknown to him or her.

A vast amount of information is available on the WWW, information easily accessible to anyone who has Internet access. However, in many situations it is desirable to limit the amount and type of information that certain individuals are permitted to retrieve. For example, in an educational setting, it may be inappropriate or undesirable for students to view pornographic or violent content while using the WWW.

In the future, it is likely that inappropriate or undesirable material will be available through other sources, in addition to the Internet. For example, such content may reside on electronic devices including but not limited to laptops, cell phones, CDs, DVDs, PDAs, MP3 and MP4 players, and the like. In the case of wireless devices, it will soon be possible to transmit and receive material from one device to another (i.e., from one student to another) without using the Internet at all.

Until now, schools and businesses have either ignored inappropriate material available on the Internet or have attempted to filter it using simple software filters. Most of these software filters suffer from several problems. First, they rely on lists of URLs which almost immediately become obsolete because of the explosive growth of sites and potentially objectionable or inappropriate material available on the WWW.

Another approach to filtering Internet content is to use an access control program in conjunction with a proxy server so that an entire network may be filtered. “Yes” lists (e.g., so-called white lists) and content filtering are other conventional methods used to control access to objectionable Internet sites.

Conventional filtering has several inherent flaws, despite the fact that it is still considered the best alternative for limiting access to inappropriate web sites or material. If a filter list is broad enough to ensure substantially complete safety (i.e., isolation of all material deemed inappropriate) for its users, harmless or appropriate material is inevitably filtered along with material considered to be inappropriate. This is similar to the concept in statistics of Type One and Type Two errors. A Type One error occurs when a hypothesis is rejected even when the hypothesis is true; that is, appropriate material is removed by the filtering process. A Type Two error occurs when a false hypothesis is accepted (i.e., is not rejected); that is, when inappropriate material is not blocked and is passed to a user.

The use of such filters leads to a reduction in the utility of the Internet and the possibility of censorship accusations being directed at the person or agency applying the filter. On the other hand, if the filter list is too narrow, inappropriate material is more likely to be passed through to the users.

Another problem with simple filters is that, typically, the filter vendor is in control of defining the filter list. This may result in the moral, ethical, or other standards or agenda of the vendor being imposed upon a user. Moreover, because new, inappropriate sites appear on the Internet on an hourly basis, and also because Internet search engines typically present newer web sites first, these newer sites that are least likely to be in a filter list are, therefore, most likely to appear at the top of search results.

A yes or white list is the safest method of protecting students or other users deemed to need protection on the Internet. However, this approach is the most expensive to administer and, by being the most restrictive, it dramatically reduces the benefits of the Internet in an educational setting. Yes lists require the teachers, parents, guardians or supervisors to research the Internet for materials they wish their students to access, and then submit the list of suitable materials to an administrator. The administrator then unblocks these sites for student access, leaving all other (i.e., non-approved) sites fully blocked and inaccessible.

Another method of managing inappropriate material is content filtering which involves scanning the actual materials (not the URL or IP or other address) inbound to a user from the Internet. Word lists and phrase pattern matching techniques are used to determine if the material is inappropriate. This process requires a great deal of computer processor time and power, slowing down Internet access and also making this a very expensive alternative. Furthermore, it is easily defeated by images, Java scripts, or other methods of presenting words/content without the actual use of text.

### DISCUSSION OF THE RELATED ART

U.S. Pat. No. 6,065,055 for INAPPROPRIATE SITE MANAGEMENT SOFTWARE, issued to Hughes et al. on May 16, 2000, discloses a method and system for controlling access to a database, such as the Internet. The system is optimized for networks and works with a proxy server. Undesirable content from the World Wide Web is filtered through a primary filter list and is further aided by a Uniform Resource Locator keyword search. Depending on the threshold sensitivity setting which is adjusted by the administrator, a certain frequency of attempts to access restricted material will result in a message being sent to an authority figure.

U.S. Pat. No. 6,389,427 for FILE SYSTEM PERFORMANCE ENHANCEMENT, issued to Faulkner on May 14, 2002, discloses a performance enhancement product that identifies what directories or files are to be monitored in order to intercept access requests for those files and to respond to those requests with enhanced performance. A system administrator can specify what directories or files are to be monitored. An index of monitored directories or files is maintained. When a monitored file is opened, a file identifier is used, thereby bypassing the access of any directory meta data information.

### SUMMARY OF THE INVENTION

In accordance with the present invention, there is provided a combination of software components forming a dynamic, “smart” system for limiting access of a predetermined set of users to inappropriate content available in a public computer, an electronic device (e.g., laptop, cell phone, CD, DVD, PDA, MP3 and MP4 player, and the like) or communications network such as the WWW. An access control mechanism having a variable sensitivity is originally set to a nominal sensitivity. Assuming that a user does not attempt to access sites known to the smart system to contain inappropriate material, the nominal sensitivity of the filter is relaxed to an even less restrictive sensitivity. However, if a particular user attempts to access a site containing inappropriate material, the sensitivity of the filter is immediately returned to the more restrictive but nominal sensitivity.

All attempts to access inappropriate material are recorded along with an associated time stamp. A temporal map is formed and a statistical analysis based on the temporal map is used to predict future patterns of access attempts by a user. The map and/or the analysis process may be adjusted with regard to both total time span and the granularity within the map to meet each particular operating requirement. The sensitivity of the access control mechanism is raised (i.e., made more restrictive) and relaxed based upon a user's pattern of attempts to access inappropriate material.

It is, therefore, an object of the invention to provide an Internet access limitation method for use with an enhancement of existing Internet filters.

It is another object of the invention to provide a system wherein the filter pass band of the enhanced filter is adjustable.

It is a further object of the invention to provide a method wherein the filter pass band responds dynamically, responsive to a user's attempt to access sites containing known, inappropriate material.

It is yet another object of the invention to provide a method wherein a temporal map is formed based upon a user attempting to access a site containing inappropriate material.

It is a still further object of the invention to provide a method wherein a statistical analysis is performed, based on information from a temporal map and such analysis is used to predict future patterns of access attempts by a user.

It is yet another object of the invention to provide a method wherein the sensitivity of an access control mechanism is adjusted based on statistical analyses and future patterns predictions.

It is another object of the invention to provide a content limitation method for use with an enhancement of existing filters, wherein the content may reside on any electronic device including, but not limited to laptops, cell phones, CDs, DVDs, PDAS, MP3 and MP4 players, and the like.

### BRIEF DESCRIPTION OF THE DRAWINGS

A complete understanding of the present invention may be obtained by reference to the accompanying drawings, when considered in conjunction with the subsequent detailed description, in which:

FIG. 1 is a high-level diagram of an access control apparatus of the prior art;

FIG. 2 is a high-level diagram schematically showing the tracker and variable band pass filter in accordance with the invention;

FIG. 3 is a detail schematic diagram of the system of FIG. 2;

FIG. 4 is a diagram of a simple, two state Finite State Machine (FSM);

FIG. 5 is a detailed FSM representation of the variable sensitivity filter of the invention;

FIGS. 6a-6c are Venn diagrams illustrating operation of the inventive filter in the context of objectionable and unobjectionable content; and

FIGS. 7a-7d are schematic representations of the frequency chain forming a selector part of the variable sensitivity filter of the invention.

### DETAILED DESCRIPTION OF THE PREFERRED EMBODIMENT

The present invention provides a method for dynamically altering the performance of access control software designed to prevent or impede a user from accessing inappropriate content on a distributed public communications network. Specifically, the present invention provides a process whereby access is relaxed when a user makes no attempts to access a known site having inappropriate content. When a user, however, does attempt to access inappropriate content, the filter becomes more restrictive, eventually relaxing as the user no longer attempts to access inappropriate material.

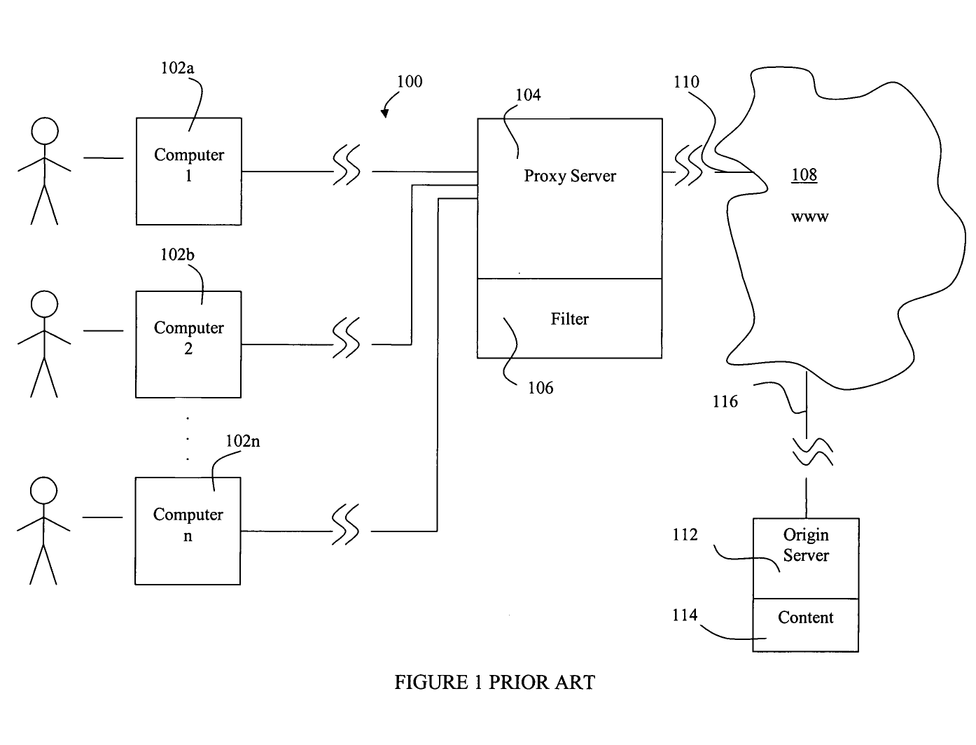

Referring first to FIG. 1, there is shown a high-level system block diagram illustrating a conventional filtering arrangement of the prior art, generally at reference number 100. Three computers or similar devices 102a, 102b, . . . , 102n representative of any number of similar computers, are shown connected to a proxy server 104. Operationally connected to proxy server 104 is a conventional access and/or content filter 106. It will be recognized that each computer 102a, 102b, . . . , 102n, while shown directly connected to proxy server 104, may be interconnected one to another using any known network topology; the direct interconnection shown is purely schematic and representational.

Proxy server 104 is shown connected to the World Wide Web (WWW) 108 via a web connection 110. An origin server 112 having content 114 available therefrom is also shown connected to WWW 108 by communications connection 116. Origin server 112 represents all possible origin servers accessible by proxy server 104 via WWW 108. In such prior art systems, filter 106 is typically static.

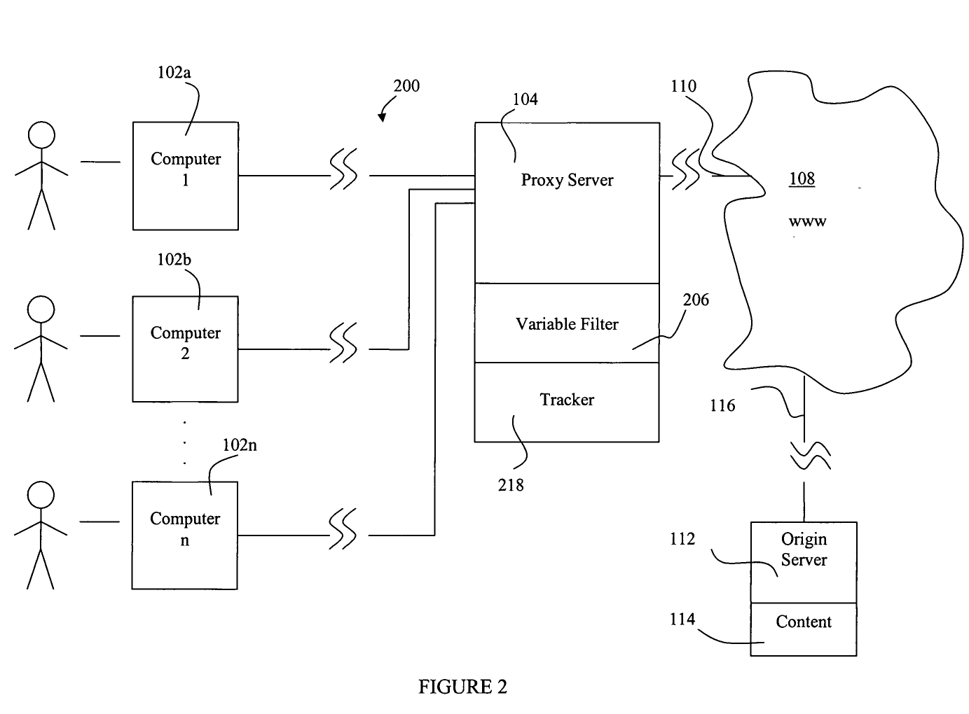

Referring now to FIG. 2, there is also shown a high-level functional block diagram similar to the prior art system of FIG. 1, generally at reference number 200. However, in system 200, filter 106 (FIG. 1) is replaced by a variable band pass, dynamic filter 206 operationally connected to a tracker 218 in accordance with the method of the invention. Dynamic filter 206 and tracker 218 are described in detail hereinbelow.

One implementation of the inventive filter 200 is available as the BAIR filter marketed by Exotrope Systems, Inc. The acronym BAIR stands for basic artificial intelligence routine.

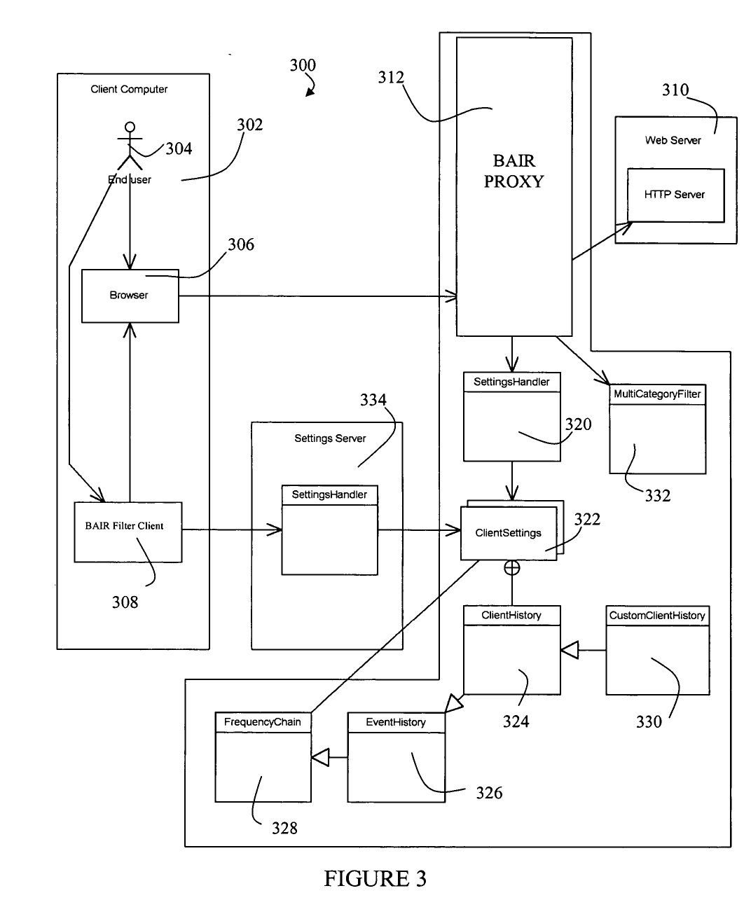

Referring now to FIG. 3, there is shown a more detailed system block diagram of the system shown in FIG. 2, generally at reference number 300. A user 304 interacts with a computer 302 via a browser 306 (i.e., Internet Explorer®, Netscape Navigator®, etc.). It should be understood that in an alternate embodiment of the invention, a client-side application of this software, independent of the WWW or any proxy servers can be used to achieve the same results via CD ROM memory stick, diskette or any other content that may arrive at a computer user's terminal (screen and/or speakers).

A small filter client program 308 installed on computer 302 interacts with browser 306. When interacting with the Internet, represented by a single web server 310, user 304 via browser 306 interacts with a proxy server 312 provided by the filtering subscription service, not shown. It will be recognized that web server 310 is representative of a vast number of web servers deployed around the globe, which collectively form the World Wide Web or Internet.

A proxy connection handler 312 is operatively connected to a settings handler 320, a client settings database 322, and a client history log 324, as well as a multi-category filter 332. Each of these components of proxy connection handler 312 is described in detail hereinbelow.

The BAIR proxy connection handler 312 is the component within the BAIR proxy that manages requests from the client computer 302, relaying them to a WWW server, and reviewing resources, such as web pages and images, as they are returned by the server before relaying them back to the client.

The client settings database 322 stores the client's filtering options and settings on the proxy handler 312. It is from these settings that proxy connection handler 312 knows what filtering operations to undertake, and what degree of restrictiveness to apply when filtering. In addition, the database is the component of the system that contains the client history component of the invention.

The client history log 324 stores the information pertaining to events generated by the client computer 302 in a time sensitive form. It is from this history log component 324 that decisions about how to alter the restrictiveness of the filter are made.

The ClientHistory pertaining to the requesting client is looked up by the proxy connection handler 324 and passed to the multi-category filter 322 along with the resource to be filtered.

Multi-category filter 322 is the component which the proxy connection handler 324 uses to review resources being relayed to the client as they are returned from the WWW server in response to the client request. Multi-category filter 322 also makes the determination as to whether to allow access to the resource before it is returned to the client.

The aforementioned components help fulfill the purpose of the invention, which is to alter the sensitivity of any filtering based on the recent history of the client as represented by the client history information passed to the filter along with the resource to be filtered.

A settings server 334 interacts with filter client 308 in computer 302 as well as with client settings database 322. The client settings server 334 is external to the proxy connection handler 312, and provides the interface by which the client's options and settings are communicated to the proxy handler 312 by the client. The client settings server 334 places the settings it receives for the client in the client settings database 322 which, in turn, is accessed by the proxy connection handler 312.

Many modeling tools are available to describe complex processes such as the operation of the dynamic filter 206 (FIG. 2) of the present invention. One suitable tool is the state diagram used to describe a finite state machine (FSM).

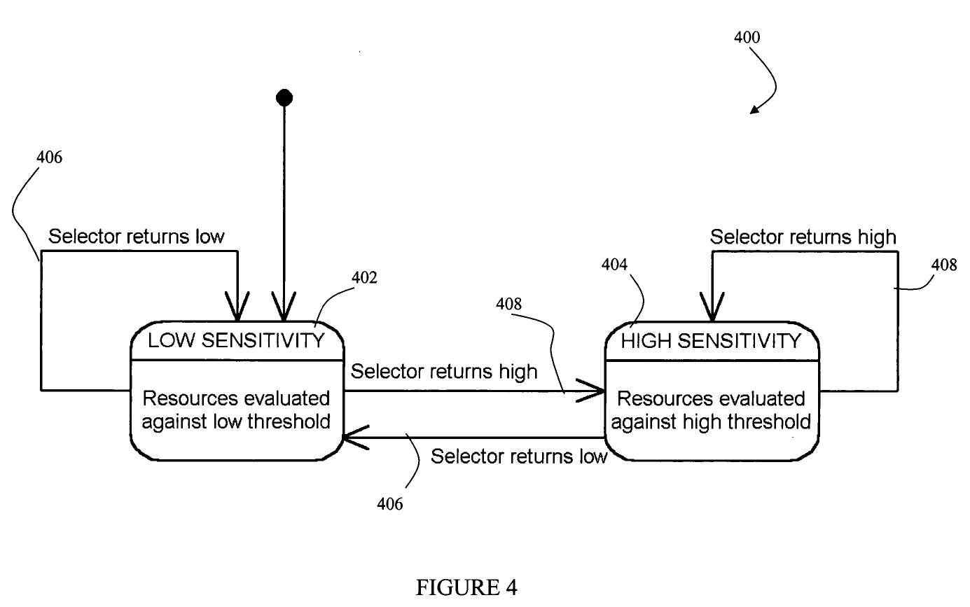

Referring to FIG. 4, there is shown a simplified, two-state example that illustrates the use of state diagrams, generally at reference number 400. Filter system 400 is modeled as a finite state machine having two possible states: low sensitivity 402 and high sensitivity 404. Filter 400 evaluates incoming material in the low sensitivity state 402 or the high sensitivity state 404 that the filter 400 is presently in. When the filter 400 is in the low sensitivity state 402, incoming information is evaluated against a low (i.e., less discriminating) threshold. Conversely, when the filter 400 is in the high sensitivity state 404, incoming information is evaluated against a high (i.e., more discriminating) threshold.

Filter 400 may switch between low sensitivity state 402 and high sensitivity state 404 based on an event. In the simple finite state machine represented by filter 400, the events are “selector returns high” 408 and “selector returns low” 406. Depending upon which state filter 400 (i.e., low sensitivity 402 and high sensitivity 404) is currently in use, the effects of events 406, 408 are different. If in low sensitivity state 402, when incoming material is evaluated and no objectionable material is noted (i.e., the selector returns low 406), the state remains in low sensitivity 402. If, on the other hand, incoming material is evaluated and objectionable material is discovered (i.e., the selector returns high 408), the state changes to high sensitivity 404.

If filter 400 is in high sensitivity state 404 when incoming material is evaluated, and the selector returns low 406, filter 400 returns to low sensitivity state 402. If, on the other hand, the selector returns high 408, filter 400 stays in high sensitivity state 404.

This simple illustration of an FSM is useful in understanding the more complex FSM representation of the dynamic filter forming part of the present invention.

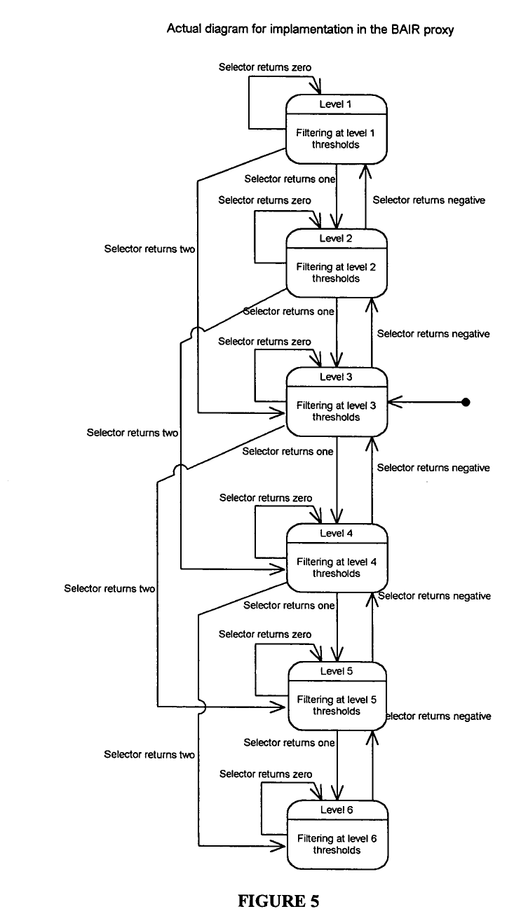

Referring now to FIG. 5, there is shown an FSM representation of a six-level filter in accordance with the invention. A selector event may return four discrete values: negative, zero, one and two. Using the same principles as described for FIG. 4, the FSM diagram may easily be understood, so a detailed, state-by-state, event-by-event description is not deemed necessary.

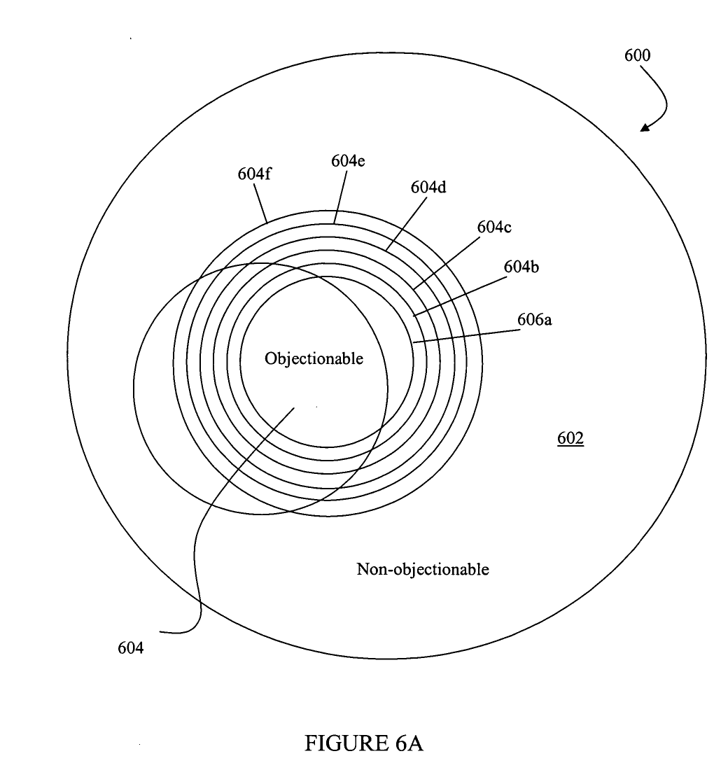

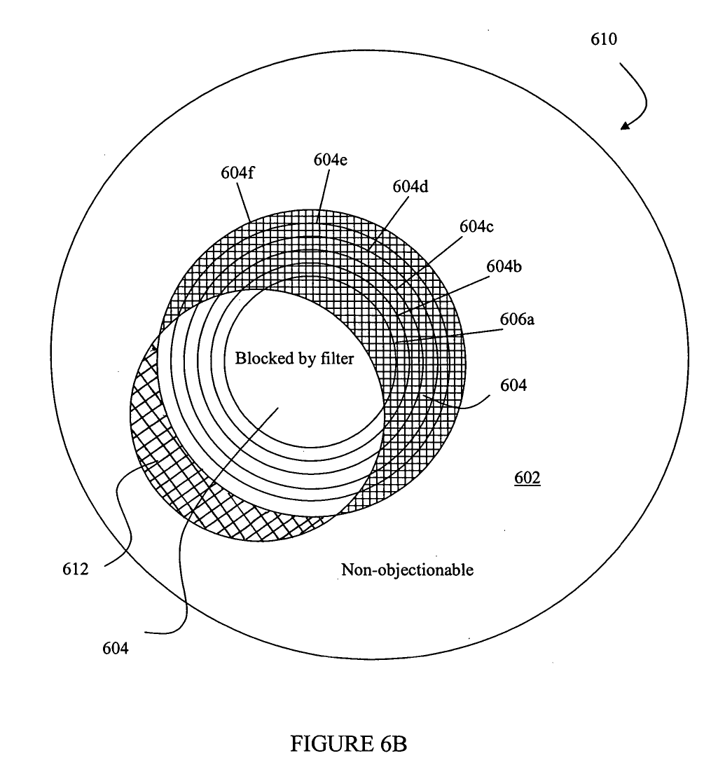

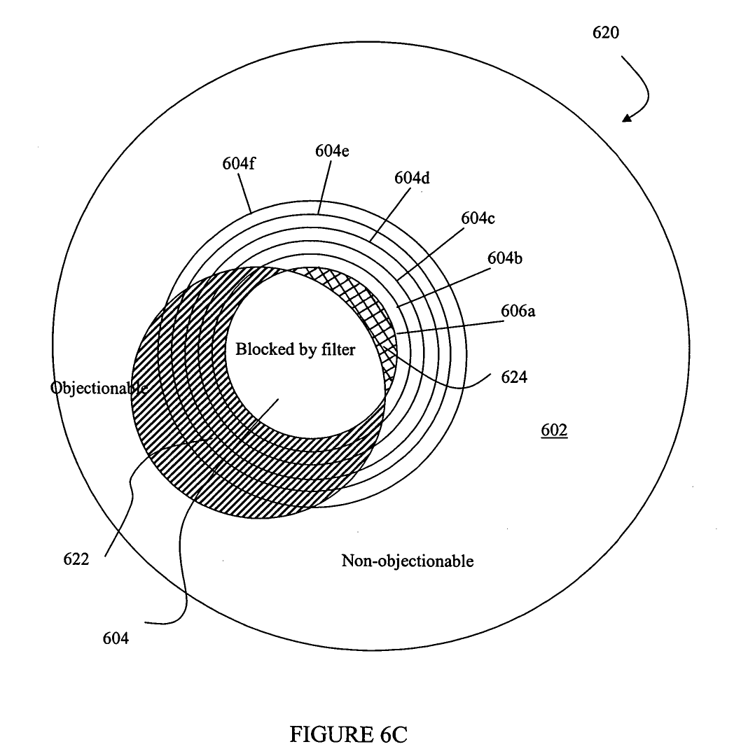

As earlier discussed, there is a constant tension between making a content filter so restrictive that excessive unobjectionable material is incorrectly blocked and making that filter so unrestrictive that objectionable material is passed by that filter. Referring now to FIGS. 6a-6d, there are shown four Venn diagrams, respectively, that illustrate how the dynamic filter of the invention help minimize these Type One and Type Two problems.

FIG. 6a shows a Venn diagram 600 of an objectionable subset 604 of the total web content 602. Venn diagram 600 also shows six concentric subsets 606a, 606b, . . . , 606f representative of the band pass of the inventive dynamic filter 206 at six different filter sensitivities, subset 606a being the least sensitive (i.e., restrictive) and subset 606f being the most sensitive. The respective intersections of subsets 606a, 606b, . . . , 606f and subset 604 (i.e., (606a∩604), (606b∩604), etc.) encompass or include greater and greater portions of subset 604. In other words, the low-sensitivity filter setting represented by subset 604a allows a greater percentage of objectionable material (i.e., subset 604) to be passed to the viewer than does the highest filter sensitivity represented by subset 606f.

Referring now also to FIG. 6b, there is shown another Venn diagram 610 similar to Venn diagram 600 of FIG. 1. An analysis of the highest filter sensitivity represented by subset 612f is provided. Errors 612, 614 represent, respectively, the objectionable material not stopped by dynamic filter 206, and non-objectionable material that was stopped, albeit in error, by dynamic filter 206. As may be observed, relatively little objectionable material is allowed to pass 612, while a relatively large amount of non-objectionable material 614 is stopped.

Referring now also to FIG. 6c, there is shown another Venn diagram 620, similar to Venn diagram 610 (FIG. 6b), except that the lowest filter sensitivity represented by subset 606a is analyzed. As may also be readily seen, there is a marked shift in the types of errors that occur when the filter sensitivity is low. Now, the relative amount of non-objectionable material blocked in error by dynamic filter 206 is relatively small (region 224) while the amount of objectionable material passed (in error) by dynamic filter 206 is relatively large (region 222).

By dynamically changing the filter sensitivity between the two extremes illustrated in FIGS. 6b and 6c, filter performance may be optimized to the behavior of a user 304 (FIG. 3). In the present invention, filter sensitivity is dynamically changed based upon two assumptions. First, it is assumed that the statistical frequency with which an event occurs defines the likelihood of a similar event occurring. That is, the likelihood of an event occurring correlates to and is a function of the frequency with which that event has occurred in the past.

Second, some events may be characterized as having an uneven distribution with respect to time. These events, however, may exhibit a historical tendency to cluster in or around identifiable time periods. In this case, the likelihood that a future event will occur in a similar manner may be shown to be a function of the degree to which events of a similar nature have historically occurred in temporal proximity.

In the case when an event may be characterized by both of the aforementioned assumptions, the likelihood of an event happening soon is assumed to be a function of the frequency with which it has occurred recently. By further extension, an exceptionally high likelihood that an event will occur soon is assumed in the case where the event can be shown to have been occurring recently with exceptional frequency.

In order to gather data from which temporal conclusions may be drawn, the present invention uses a frequency chain to store data regarding a recordable event: an event that indicates a user 302 (FIG. 3) is engaging in a known or suspected improper activity.

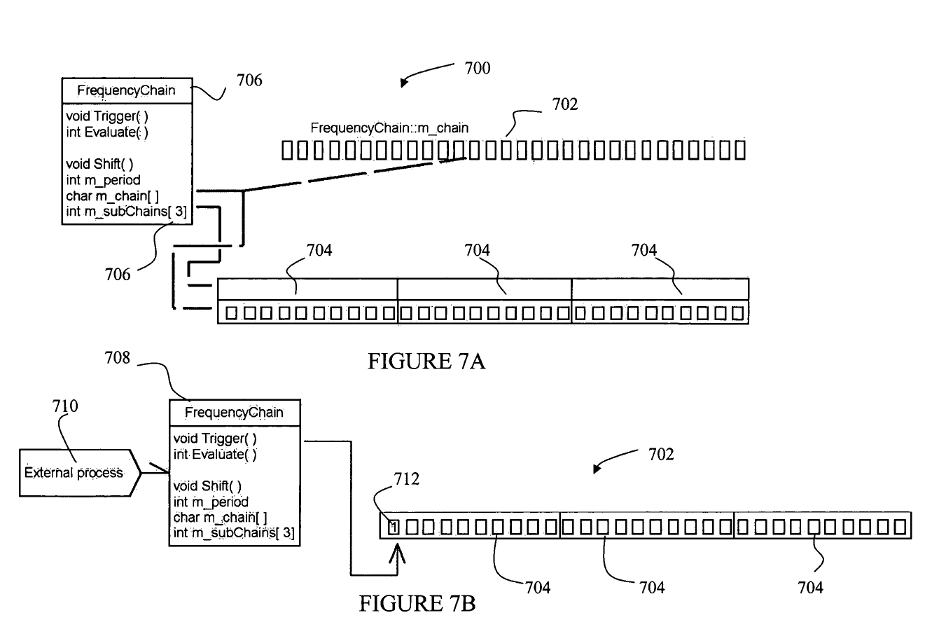

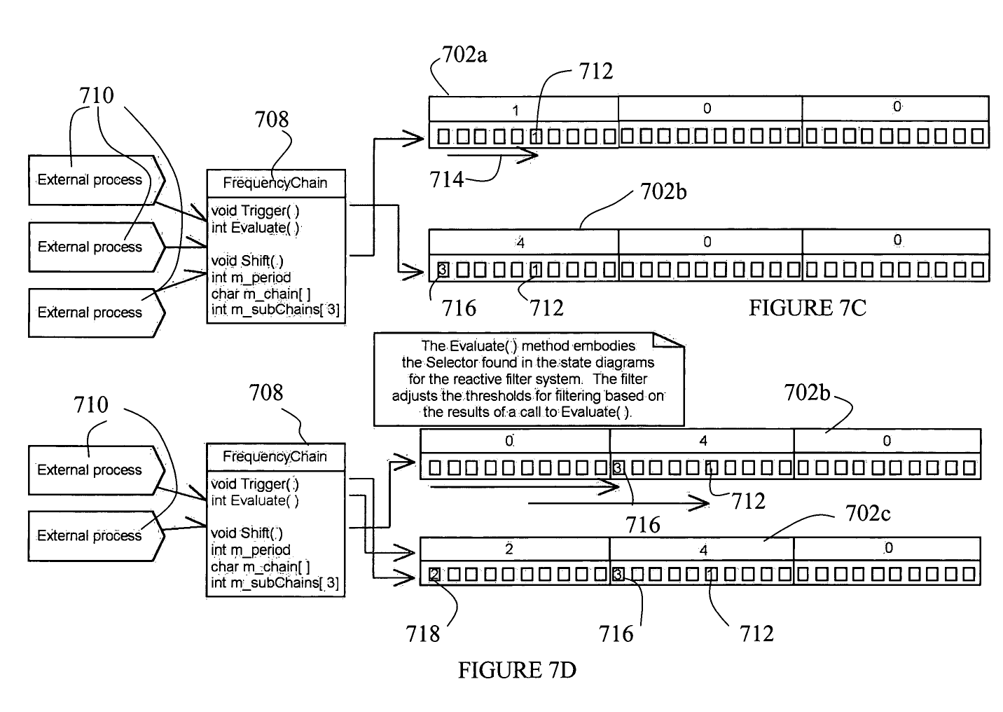

Referring now to FIG. 7a, there is shown a schematic representation of one possible implementation of a frequency chain, generally at reference number 700. The frequency chain 702 may be an array of integers which are all initialized to zero. Each element of frequency chain array 702 represents an arbitrary period of time, that arbitrary period of time defining the granularity (i.e., time resolution) of frequency chain 702. The value stored in each integer or element of frequency chain 702 represents the number of times during the arbitrary time period that an event of the type recorded by frequency chain 702 occurred. The length of frequency chain 702 is arbitrary and the total time period covered by frequency chain 702 is the product of the number of elements therein and the granularity thereof. For example, a 60-element array having a granularity of 1 second would cover a 1 minute period.

In one implementation of the method of the invention, a C++ class or object, FrequencyChain, represented schematically at reference number 708, is used to store the frequency chain array 702. As shown in FIG. 7a, frequency chain array 702 is empty. In addition to the frequency chain 702 array, the FrequencyChain class 708 stores a timestamp that records the last time that an event was recorded.

The array of integers (i.e., frequency chain 702) is broken into m sub-chains 704, m typically having a value of 3. Sub-chains 704 are generally of equal length. When later analyzed, as described in detail hereinbelow, frequency chain 702 is evaluated according to the distribution of events over these m equal-length sub-chains 704.

Referring now to FIG. 7b, when an external process 710 signals that a recordable event has occurred, the Trigger( ) method increments the first element 712 in frequency chain 702, thereby recording the event.

Referring now to FIG. 7c, a Shift( ) method is called by either an Evaluate( ) or Trigger( ) method and operates upon FrequencyChain to move elements down the chain a distance (i.e., a number of elements) corresponding to the time that has elapsed since the last call to the Shift( ) method. Frequency chain 702 is shown schematically as frequency chain 702a which represents frequency chain 702 as shown in FIG. 7b, and frequency chain 702b, which represents frequency chain 702a after shifting and recording of a new event. Element 712 is shown shifted five time periods as shown by arrow 714 in frequency chain 702a. In frequency chain 702b, element 712 is shown shifted and a new event is shown recorded in the new first element 716 in the shifted frequency chain 702b. Shifting is typically performed before recording another event in the chain or before evaluating frequency chain 702. The distance (i.e., the number of time periods) the elements must be shifted is calculated by the system.

In the frequency chain embodied in the inventive filter, timestamps are recorded, as is typically the case in UNIX computer systems, as seconds elapsed since the so-called Epoch. In UNIX terms, the Epoch began Jan. 1, 1970. The number of elements to shift is calculated by subtracting the last timestamp from the current timestamp, and dividing the result by the granularity of the chain. The modulus of the division operation, if any, is retained and subsequently added to the current timestamp, which then becomes the last timestamp for subsequent iterations of this calculation.

The number of seconds that have elapsed since the Epoch is a value to be interpreted according to a formula for conversion from UTC equivalent to conversion, ignoring leap seconds and defining all years divisible by 4 as leap years. This value, however, is not the same as the actual number of seconds between the time and the Epoch, because of leap seconds and because clocks are not required to be synchronized to a standard reference. The intention is merely that the interpretation of seconds since the Epoch values be consistent.

It will be recognized by those of skill in the programming arts that any one of a number of languages and/or other algorithms may be used to calculate the required shift. Consequently, the invention is not considered limited to one specific programming language or algorithm.

Referring now to FIG. 7d, frequency chain 702b is shown further shifted and a new event is recorded in the new first element 718 of frequency chain 702c. An Evaluator( ) method forms the Selector shown in the state diagrams of FIGS. 4 and 5 of the dynamic (i.e., reactive) filter 206 (FIG. 2) of the invention. Filter 206 adjusts its sensitivity dependent upon the evaluation of frequency chain 702 and, more specifically, upon the relationship of the m equal sub-chains 704. The selector determines a value based on a call to the Evaluate( ) method.

In the filter of the invention, the sum of all elements in each of sub-chains 1, 2, and 3 is representative of “very recent,” “recent,” and “somewhat recent” activity, respectively. The values arrived at are then compared with predetermined thresholds representing the value at or above which the calculated sums are to be deemed indicative of undesired behavior, and to what extent. Multiple thresholds are tested against for each sub-chain producing an interim value representative of the extent to which the contents of the sub-chain are to taken as inappropriate. Thresholds are higher, resulting in less sensitivity, as sub-chains become less recent, resulting in a variable amount of weight applied in the calculation of the interim values based on how recently the recorded events occurred. The aggregate assumed risk of access to inappropriate materials on the part of the client is then arrived at by comparing the sum of all sub-chains to additional defined thresholds representing high, moderate, non-existent, or negative aggregate risk, which correspond to the 2, 1, 0, or −1 responses returned by the state change selector.

In the example chosen for purposes of disclosure wherein frequency chain 702 has a length of 60 elements, and a period (i.e., granularity) of 1 second, the first element (element indexed at 0) of the array contains the number of times the event recorded by the chain occurred over the most recent second, and the last (element indexed at 59) element contains the number of times the event occurred during the second that happened one minute ago.

In the example chosen for purposes of disclosure wherein frequency chain 702 has a length of 60 elements, and a period (i.e., granularity) of 1 second, the first element (element at index 0) of the array contains the number of times the event recorded by the chain occurred over the most recent second; the second element (element at index 1) contains the number of times the event occurred between one and two seconds ago; the third element records the events occurring between two and three seconds ago; etc. The 60th and final element (element indexed at 59) contains the number of times the event occurred during the second between 59 and 60 seconds ago.

In the preferred embodiment of the inventive method, it is presumed that normally no events have been recorded in frequency chain 702. In this case data is sufficiently continuous that relatively low resolution of data is sufficient. This also makes trivial the task of evaluating the trend represented by the data. In other cases, higher data resolutions are required and the evaluation task is more complex; a more sophisticated evaluation algorithm may be required to recognize the trends.

In some cases, the temporal distribution of an event will be shown to exhibit considerable variation in both temporal distribution and quantity of the events. In cases where events typically vary a great deal in frequency, the trend can still be observed, although the effort required in evaluating the stored data may quickly exceed any benefits derived from such analysis. In some such cases, it is possible to mitigate these effects by altering the recording period and/or the granularity of the data.

In recording events in which the typical case is characterized by high fluctuations over short periods, but tends to be more consistent over somewhat longer periods, the trend may be less easily evaluated by simple algorithms. One way of mitigating such a high fluctuation trend is to reduce the granularity of the data stored. This has the benefit of retaining simplicity in the overall system. The overall effect of reducing granularity is to form what is technically a type of low pass filtering of the data signal represented by the event frequency data. High-frequency components (highly transient data over short periods) of a sample are blocked out in order to emphasize the low frequency ones, with less short term transience, thus reducing transient response distortions in the recorded event data. However, the downside of this approach is that, as data is accumulated into fewer containers (i.e., time periods), a portion of the associated timing information is lost.

Another way of mitigating a trend in which the typical case is undesirably noisy is to increase the chain length or total time period over which data is retained. The down side of this approach is that evaluating the sub-system must generally be more complex. However, when higher data resolution is required, a trained Artificial Neural Network, not shown, may be employed as an evaluator to recognize the trends in the data. Typically, in the preferred embodiment of the invention, data is sufficiently continuous so that the added complexity of an Artificial Neural Network is not required.

Two applications illustrating the inventive, dynamic filtering method are now described. In the first application, the use of the inventive techniques as a text filter for detecting pornographic or other undesirable content in an HTTP proxy environment is described.

Refer again to FIG. 3. Proxy connection handler 312 refers to the text filtering software residing on a computer. Client computer 302 is the computer that directs requests from user 304 for Hypertext Transfer Protocol (HTTP) requests to the proxy connection handler 312 and to which the proxy handler 312 sends either a requested resource or an indication that the resource has been denied. HTTP is the protocol, or the form the request must take in order to communicate with an HTTP (web) server. The HTTP request is a request for, usually, an HTML document, image, sound, etc. The requests for HTTP are forwarded by proxy handler 312 to be forwarded to an origin or web server 310. Origin server 310 is an HTTP server on which the requested resources reside and is representative of vast numbers of similar, interconnected origin/web servers connected to the WWW.

Proxy connection handler 312 is tasked with examining both requests for resources from user 304, as well as examining the resources themselves as they are returned from origin/web server 310. The examination process attempts to locate undesirable content and prevent such content from being returned to the requesting client 302 and user 304. The filter embodied in proxy handler 312 implements the inventive process as a way of tracking the recent history of the client 302 and user 304. The operation of proxy handler 312 is described herein as though only a single client 302 interacts therewith. In actuality, numerous clients 302 may substantially simultaneously interact with proxy connection handler 312.

A frequency chain class 702 (FIGS. 7a-7d) is instantiated and maintained separately for each client 302 using the proxy handler 312. Each respective frequency chain 702 is coupled or paired with a discrimination module or filter. In this case, the event being tracked is the group of instances wherein the client 302 has been denied access to a resource because of detected pornographic content. While pornographic content has been chosen for purposes of illustration, many other content types may be defined as objectionable content in other embodiments of the inventive method. The invention is clearly applicable to other content-related detection cases and therefore is not restricted to pornography, per se. Proxy handler 312 acts as an intermediary for communications between an arbitrary number of clients 302 and origin/web servers 310.

Initially, the client 302 has no history of being denied access to any resources, and no historical data is stored anywhere between sessions. The assumed trend is that no recorded events will occur in normal operation, so this is the assumed baseline condition.

When a resource is requested by client 302 through the proxy handler 312, the various filters, not shown, query the tracking facility for the history of this client 302. Over the course of a few minutes, the client 302 may request multiple resources through the proxy handler 312, and filters detect no pornographic content in the resources requested. Consequently, the client is not denied access to any resources.

However, over the next few minutes in this example, pornographic content is detected twice, and the client is denied access to two resources. When the various filters query the tracking facility, no action is immediately taken, as this may very well be the result of errors on the part of the filter, or may simply be accidental on the part of the client 302. In either event, this trend is not assumed to indicate intent on the part of the user. However, resources have been blocked. The times when these blocking events have occurred are recorded in the tracking facility.

Over the course of the next few requests, the client 302 is denied access to five additional resources. In the normal course of detection, the various filters query the tracking facility, which responds with an indication that recent activity implies an active attempt on the part of the user to obtain such materials as the filter detects. This evaluation is based on the assumption, stated earlier, that an exceptionally high likelihood that an event will occur soon is assumed in the case where the event can be shown to have been occurring recently with exceptional frequency. Therefore, the filter increases its own sensitivity because of the increased number of requests for inappropriate material.

Over the course of the next few minutes in this example, the trend continues, with the client 302 repeatedly being denied access to resources. Correspondingly, the recorded trend indicates an ever-higher likelihood that this is an active attempt on the part of the user 304 to access pornographic material. This causes a corresponding increase to the sensitivity and strictness on the part of the filter.

Repeated failure to obtain access to blocked material eventually causes the user 304 to request pages (i.e., resources) that are not denied. After a few minutes of undenied access activity, the filter lowers its sensitivity, again based on results of its queries to the tracking facility. This reduces the likelihood of the filter falsely identifying the presence of pornographic content, and subsequently denying access to resources that should, in fact, be allowed to pass through to the client 302. After a continued period of time during which the client 302 is denied no resources, the filter returns to its customary filtration level.

The second example provided herein for purposes of disclosure is an e-mail filter tasked with detecting a Mail Transport Agent (MTA) that is being used to distribute large quantities of unsolicited e-mails commonly known as “spam.” In this second example, the filter is integrated with an MTA that is tasked with the normal processing of e-mail for an organization of arbitrary size. The filter incorporates the inventive method as a means of recording and evaluating the frequency of communications between the MTA of which it is a part, and various other MTAs with which it exchanges e-mail messages.

During normal operation, some MTAs will be more active than others in terms of how often they send to or receive from the monitored MTA, so the filter maintains a separate event history for each MTA. Event data is retained at a variety of periods and granularities in order to provide both overall, long-term trends in activity from that host, as well as trends related to periods of higher activity. That is to say, an increase in activity from a host may be normal in the overall trend but still exhibit abnormal properties consistent with abuse. In addition, the tracking facility retains event data that records the rejection of messages from that host. This example concerns itself with the data gathered on a single such peer MTA.

Initially, the filter carries no recorded data. In the case of MTA communications, this may very well not be representative of the norm, so until a trend is established, the tracking facility reports no unusual activity. In this example, unlike in the first example described hereinabove, because data is retained for extensive periods, event data is retained on a semi-permanent medium (a file on disk), so that stopping and restarting the processes do not result in a need to reestablish the trend each time the process is begun.

However, once a trend is established, the event tracking facility begins responding with evaluations when queried. It can be assumed that the filter has always queried the tracking facility, but has always received a response indicating that no deviation from the normal trend of events is present.

This example presents the case of a peer MTA that normally communicates a few dozen emails to the local MTA per day, and sometimes as many as 15 in close succession. Given that case, and in the event that in the recorded period of the most recent ten minutes, the peer MTA in question has been seen to be sending 60 mails per minute, the filter receives an item of mail, triggers the event tracking facility as usual, then proceeds to evaluate the likelihood that this current message is spam. One factor to be considered when evaluating the message is whether the sending MTA has recently been passing an extraordinary number of messages. The tracking facility analyzes recent event data, in combination with the long-term trends exhibited by the associated MTA, and makes a determination that the MTA in question has been sending an extraordinary volume of messages recently, and that this volume is not consistent with past instances of increased activity. The tracking facility replies to the filter's query indicating that the current trend is irregular. Consequently, the filter increases its sensitivity for the purpose of detecting unsolicited junk mail.

Based on the filter's evaluation, it may respond by passing or rejecting the message. If the mail is rejected, the rejection event is recorded with the tracking facility as well. With an increase in the number of rejections, the tracking facility may begin responding to queries with an indication that not only has traffic been uncharacteristically high from this host, but there has also been an increase in the number of rejected messages from this host, which may be taken as a further indication to the filter that the message currently in transit is unsolicited, and possibly undesired by the intended recipient of the message. As such activity continues, the filter may list the MTA as a host that may not connect.

Since other modifications and changes varied to fit particular operating conditions and environments or designs, including programming for applications residing solely on a client/stand-alone PC, will be apparent to those skilled in the art, the invention is not considered limited to the examples chosen for purposes of disclosure, and covers changes and modifications which do not constitute departures from the true scope of this invention.

Having thus described the invention, what is desired to be protected by letters patents is presented in the subsequently appended claims.

1. A method of controlling access to objectionable content from a communications network, the steps comprising:
a) producing a list of objectionable content;
b) monitoring a flow of data on a communications network;
c) detecting presence of objectionable content associated with said list of objectionable content in said flow of data;
d) recording an event and a time parameter associated therewith into a history of events when the presence of objectionable content associated with said list of objectionable content is detected in said flow of data;
e) analyzing a predetermined portion of said history; and
f) adjusting the sensitivity of a filter operatively disposed to control said flow of data on said communications network based at least in part on said analysis of said predetermined portion of said history.

2. The method of controlling access to objectionable content from a communications network as recited in claim 1, wherein said list of objectionable material comprises at least one of the items: an objectionable term, a domain name of a domain known to include objectionable material, a URL of a domain known to include objectionable material, graphic images, and meta-information about a graphic image.

3. The method of controlling access to objectionable content from a communications network as recited in claim 2, the steps further comprising: periodically updating said list of objectionable material.

4. The method of controlling access to objectionable content from a communications network as recited in claim 1, wherein said history comprises a frequency chain comprising a plurality of elements, each adjacent element being associated with a predetermined, substantially contiguous time period.

5. The method of controlling access to objectionable content from a communications network as recited in claim 4, wherein said frequency chain comprises an array of integers, each integer being associated with one of said elements and representing a count of detected events occurring during said predetermined time period.

6. The method of controlling access to objectionable content from a communications network as recited in claim 4, wherein said frequency chain comprises a histogram of detection counts within each of said predetermined time periods.

7. The method of controlling access to objectionable content from a communications network as recited in claim 5, wherein said array of integers forming said frequency chain are subdivided into at least two sub-chains of substantially equal length.

8. The method of controlling access to objectionable content from a communications network as recited in claim 7, wherein said at least two sub-chains comprise three sub-chains of substantially equal length.

9. The method of controlling access to objectionable content from a communications network as recited in claim 8, wherein said frequency chain comprises approximately 60 elements and each of said three sub-chains comprise sub-chains of approximately 20 elements.

10. The method of controlling access to objectionable content from a communications network as recited in claim 5, wherein said analyzing step (e) comprises shifting said detection counts in said elements of said frequency chain by a number of elements representative of an elapsed time since the last occurrence of said detected event.

11. The method of controlling access to objectionable content from a communications network as recited in claim 1, wherein said time parameter comprises a time stamp.

12. The method of controlling access to objectionable content from a communications network as recited in claim 5, the steps further comprising:
g) using an allowable list to override any adjusting of sensitivity of said filter.

13. The method of controlling access to objectionable content from a communications network as recited in claim 12, wherein said allowable list comprises at least one of the items: an objectionable term, a domain name of a domain known to include objectionable material, a URL of a domain known to include objectionable material, graphic images, and meta-information about a graphic image.

14. The method of controlling access to objectionable content from a communications network as recited in claim 12, wherein said allowable list comprises a white list.

15. A system for controlling access to objectionable material from a communications network, comprising:
a) a client computer adapted to generate HTTP resource requests to a network and to receive said resources therefrom;
b) an origin server operatively connected to said communications network and adapted to receive an HTTP resource request and to return said requested resource;
c) a proxy server operatively disposed between said client computer and said origin server and adapted to evaluate data flowing therebetween, said proxy server comprising means for filtering said data flowing between said client computer and said origin server;
d) means for detecting objectionable material adapted to monitor said data flowing between said client computer and said origin server, and generating a detected event output when objectionable material is detected in said data; and
e) means for tracking operatively connected to said means for filtering and adapted to control a sensitivity thereof in response to said detected event output.

16. The system for controlling access to objectionable content from a communications network as recited in claim 15, wherein said objectionable material comprises at least one of the items: an objectionable term, a domain name of a domain known to include objectionable material, a URL of a domain known to include objectionable material, graphic images, and meta-information about a graphic image.

17. The system for controlling access to objectionable content from a communications network as recited in claim 16, further comprising: means for periodically updating at least one of said items.

18. The system for controlling access to objectionable content from a communications network as recited in claim 15, further comprising a frequency chain comprising a plurality of elements, each adjacent element being associated with a predetermined, substantially contiguous time period.

19. The system for controlling access to objectionable content from a communications network as recited in claim 18, wherein said frequency chain comprises an array of integers, each integer being associated with one of said elements and representing a count of detected events occurring during said predetermined time period.

20. The method of controlling access to objectionable content from a communications network as recited in claim 18, wherein said frequency chain comprises a histogram of detection counts within each of said predetermined time periods.

21. A method of controlling access to objectionable content on an electronic device, the steps comprising:
a) producing a list of objectionable content;
b) monitoring a flow of data from any input or storage device via a GUI to a computer terminal;
c) detecting presence of objectionable content associated with said list of objectionable content in said flow of data;
d) recording an event and a time parameter associated therewith into a history of events when the presence of objectionable content associated with said list of objectionable content is detected in said flow of data;
e) analyzing a predetermined portion of said history; and
f) adjusting the sensitivity of a filter operatively disposed to control said flow of data onto said computer terminal based at least in part on said analysis of said predetermined portion of said history.

22. The method of controlling access to objectionable content on an electronic device as recited in claim 21, wherein said electronic device is one of the group: laptops, cell phones, memory sticks, diskettes, CD ROMs, CDs, DVDs, PDAs, MP3 players and MP4 players.
